(19) United States
(12) Patent Application Publication
(10) Pub. No.: US 2002/0083029 A1
(43) Pub. Date: Jun. 27, 2002

(54) Virtual domain name system using the user's preferred language for the internet

(76) Inventors: Won Ho Chun, Fullerton, CA (US); Sung Jae Shim, Wayne, NJ (US)

Correspondence Address: FLESHNER & KIM, LLP, P.O. Box 221200, Chantilly, VA, 20153-1200, US

(21) Appl. No.: 09/982,933

(22) Filed: Oct. 22, 2001

Related U.S. Application Data
(60) Provisional application No. 60/243,068, filed on Oct. 23, 2000.

(51) Int. Cl. G06N 5/00; G06F 17/00

(52) U.S. Cl. 706/45

(57) ABSTRACT

This invention describes a system that allows a user to enter domain names in any language of the user's preference by automatically converting them into the corresponding real domain names in English that comply with the Domain Name System. The system incorporates two conversion methods. The first method is to convert the coded portions of a domain name such as organization code and country code. In this method, each coded portion in English is pre-assigned an equivalent word or code in the user's preferred language, and the equivalent word or code entered in the user's preferred language is converted into the corresponding real coded portion in English. The second method is to convert the remaining portions of a domain name such as organization name and server computer name. In this method, the user enters each portion in the user's preferred language as the corresponding real portion in English is transliterated into the user's preferred language in accordance with the standard pronunciation of English words or letters in the user's preferred language. Then, the letters of the portion entered in the user's preferred language are converted into English letters by matching the phonemes of the portion entered in the user's preferred language with English phonemes that have the same or proximate sounds and transcribing the English phonemes into the corresponding English letters. The conversion system of the present invention can be implemented automatically at the user's computer without having to change the Domain Name System.

### RELATED APPLICATION

This application claims the benefit of co-pending U.S. Provisional Application Ser. No. 60/243,068, filed Oct. 23, 2000, entitled “Virtual Domain Name System Using The User's Preferred Language for The Internet.”

### BACKGROUND OF THE INVENTION

1. Technical Field

The present invention relates generally to computers and various other devices connected to the Internet such as mobile phones, PDAs, TV set-top boxes and Internet appliances. More specifically, the invention deals with a system that allows the Internet user to enter Virtual Domain names in any language of the user's preference by automatically converting them into the corresponding Real Domain name(s) that fully comply with the DNS.

2. Description of the Related Art

The Internet is a worldwide communication network through a series of protocols known collectively as the Transmission Control Protocol/Internet Protocol (TCP/IP). Each computer connected to the Internet has a unique IP address that identifies the computer as a host on the Internet. Originally, the IP address is in the form of four decimal numbers separated by dots. As numeric IP addresses are difficult to remember, the Domain Name System (DNS) provides a user-friendly and mnemonic name equivalent of each numeric IP address. The DNS overlays the IP address of each host on the Internet with a unique series of alphabets called a domain name. Each domain name corresponds to exactly one IP address. Domains on the Internet are first classified into one of top-level domains. The top-level domains currently used include generic categories such as com, edu, gov, int, mil, net, and org that are mainly used in the United States and geographic categories including country codes such as kr, uk, and so on that are mainly used in the other countries.

Domain names are typically in the form of ‘hostname.entityname.entitycode’ (e.g., ‘www.yahoo.com’) or ‘hostname.entityname.entitycode.countrycode’ (e.g., ‘www.yahoo.co.kr’). The portion of ‘hostname’ is typically the name of the server host or cluster of server hosts connected to the Internet. The portion of ‘entityname’ is often the name of the entity that has the domain name. The portion of ‘entitycode’ is the organization code for the entity. In the example of ‘www.yahoo.com,’ ‘www’ is the name of the server host (third-level domain), ‘yahoo’ is the name of the entity (second-level domain), and ‘com’ is the organization code for the entity (first-level domain). Most domain names in the United States are in this form as they omit the portion of ‘countrycode.’ The portion of ‘countrycode’ is the code for the country where the entity is located. In the example of ‘www.yahoo.co.kr,’ ‘www’ is the name of the server host (fourth-level domain), ‘yahoo’ is the name of the entity (third-level domain), ‘co’ is the organization code for the entity (second-level domain), and ‘kr’ is the country code of Korea (first-level domain). Most domain names in countries other than the United States are in this form. There may be more than one sub-domain under the portion of ‘entityname,’ whereupon any two adjacent sub-domains are separated by a dot in between.

Domain names are valuable to Internet users as a main identifier of hosts on the Internet. But the current DNS uses mainly English in naming hosts or clusters of hosts on the Internet. More specifically, the DNS uses only the letters of the basic Roman alphabet (case-insensitive), the decimal digits (0-9) and the hyphen (-). While domain names with these letters are easy to remember and type for those who understand English, they are cumbersome for those who do not understand English. There are many current as well as potential users of the Internet who speak and read languages that are less universal than English, and this fact can diminish the international scope of the Internet. Given the large number of people who do not understand English as well as the wide range of uses of domain names on the Internet, it is highly desirable to allow using not only domain names in English but also alias in other languages that are less universal but easier to remember and type in local contexts.

The Internet community has begun to recognize the need for domain names in other languages. In order to make the Internet truly international, several methods have been proposed for using domain names in other languages on the Internet. In general, these methods proposed so far can be classified into two groups. One group of methods proposes to introduce a new “zero-level” domain building the root of a new domain branch and encode the Universal Character Set (ISO 10646 or Unicode) into the limited set of domain names. But these methods put too much of a burden on the DNS and create complex dependencies with semantics. Instead of using a special encoding and burdening the DNS, another group of methods propose to build and use a separate directory service for domain names in other languages. But defining unique domain names again for separate services duplicates much of the work already done for the DNS, requires complex implementation efforts, and does not solve a capacity problem with the DNS.

Internet domain names are registered only in Roman languages (Roman Language) under current Domain Name System (DNS). These Roman domain (Roman Domain) names are very difficult for the Internet users using non-Roman local languages (Local Language). Some non-Roman Internet communities try to develop a separate domain name system (Local DNS) or something of the kind to register domain names using the alphabets of Local Languages (Local Domain). Others register keywords of their own languages (Local Keyword) and build databases of Local Keywords and matching Roman Domains. When non-Roman Internet users request Local Keywords, the Local Keyword system searches for matching Roman Domain and return the matching Roman Domain. Third group converts Local Language alphabets into a combination of meaningless Roman alphabets using their own special conversion systems, and registers the meaningless Roman alphabet combination (Meaningless Roman Domain). Then, when non-Roman Internet users request Local Domains, Meaningless Roman Domain converts the requested Local Domains into the matching Meaningless Roman Domains, searches for the IP addresses of the Meaningless Roman Domains, and returns corresponding IP addresses. All of theses methods require additional domain or keyword registration, and/or need to build a separate Local DNS or Keywords databases. Such Local DNS, Local Keyword databases and Meaningless Roman Domains will only be isolated from the global Internet users. The global Roman Internet users cannot access to Local DNS, Local Keyword databases and Meaningless Roman Domains because of language problems. Such methods will also require cost to build and maintain them. In addition, such methods may cause trade mark problems among domain names of different languages because ‘ [symbol] ’ the Korean Local Domain corresponding to ‘yahoo.com’ of English Domain may be registered by a different entity or an individual. These trademark problems may arise among different Local Domain systems and different languages. Also, the access coverage of the aforementioned Local Domain systems will only be limited to registered Local Domains and, therefore, significant number of global domains still cannot be accessed using Local Languages of Internet Users.

### SUMMARY OF THE INVENTION

An object of the present invention is to provide a system that Virtual Domain names are fully compatible with the current DNS without having to change the DNS so that Internet navigation of the present invention is same as that of Real Domain names.

Another object of the present invention is to provide a system that allows Internet users to use both Real Domain name in Roman Language and Virtual Domain name in Local Language for the same Internet site. (Internet users can connect to the same Internet site no matter what languages are used in entering domain names, such as English, Korean, Japanese, Chinese and other local languages.)

Yet another object of the present invention is to provide a system that preserves the syntax of current domain names, that is, the hierarchical dotted notation, with which Internet users are familiar. The Virtual Domain names of Local Languages duplicate or proximate the structure of the Real Domain names of Roman Languages.

Still another object of the present invention is to provide a system that the Virtual Domain names of Local Languages have the same or proximate phonemes of the Real Domain names of Roman Languages so that Internet users can intuitively guess the Virtual Domain names of the Real Domain names of Roman Languages.

Still another object of the present invention is to provide a system that Local Domain names are not required to additionally register into any databases or name servers once corresponding Roman Domain names are registered in the current DNS system. (Under the present invention, only one registration is needed while other Local Domain systems require several registrations for different languages.)

Still another object of the present invention is to provide a system that converts a Virtual Domain name into a Real Domain name with one-to-one matching method using the numbered Virtual Domain name method or using the encryption matching method, or one-to-many matching method at the same time.

Still another object of the present invention is to provide a system that decomposes and converts the phonemes of Virtual Domain names entered in local alphabets to the Roman alphabets of Real Domain names by transliterating the phonemes of the original local words included in the Virtual Domain names to the Roman alphabets in accordance with standard pronunciation of the Local Language and by transliterating the phonemes of the Roman words included in the Virtual Domain names entered in local alphabets to the corresponding Roman alphabets in accordance with the Roman spelling. (For example, ‘www. [symbol] of Korean Virtual Domain name is converted to ‘www.samsungmall.com’ of English Real Domain name. ‘ [symbol] is transliterated into ‘samsung’ in accordance with a standard Korean pronunciation or customary transliteration method, and ‘ [symbol] is transliterated into ‘mall’ in accordance with the English spelling.)

Still another object of the present invention is to provide a system that transliterates the Virtual Domain names with similar phonemes of Local Language to the same Real Domain name so that Internet users can connect to the same site even if the Virtual Domain names with similar phonemes of Local Language are entered in different alphabets of Local Language. (For example, ‘www. [symbol] and ‘www. [symbol] of Korean Virtual Domain names are transliterated into the same ‘www.good.com’ of Real Domain name).

Still another object of the present invention is to provide a system that may reduce the trade mark issues of Internet domain names as Virtual Domain names have the same or proximate phonemes of Real Domain names. (For example, ‘www. [symbol] of Korean Virtual Domain name is most likely transliterated to ‘www.microsoft.com’ of English Real Domain name. As ‘ [symbol] is the Korean company name of ‘Microsoft,’ the present invention can help to reduce trademark issues, which may be raised under different Local Languages. Since, under other Local Domain systems, each entity or individual is required to register Local Domains in different Local Languages and in accordance with different registration methods depending on each Local Domain system, the entities or individuals should register their domain names in different languages and under different systems to protect their trademarks.)

Still another object of the present invention is to provide a system that the local words representing industry codes included in Virtual Domain names may be translated to the Roman words representing the same industries of Real Domain names. (For example, ‘ [symbol] of Korean Virtual Domain is translated to ‘bank’ of English Real Domain.)

Still another object of the present invention is to provide a system where the conversion from Virtual Domain names in the Local Language into their corresponding Real Domain names in English takes place automatically and is transparent to the user.

Still another object of the present invention is to provide a system that can be implemented at the user host and so does not need any separate directory service for the conversion.

Still another object of the present invention is to provide a system that lists the information of similar sites in business nature, the sites of competing companies, alternative product sites and other useful sites depending on the Virtual Domain names entered and the Real Domain name(s) converted so that Internet users can move to the similar sites easily by clicking the listed information. The present invention deals with a system that allows the Internet user to enter domain names in any language of the user's preference. More specifically, the system automatically converts domain names entered in the user's preferred language into the corresponding real domain names in English that comply with the DNS. For purposes of description herein, the language of the user's preference shall be referred to as “Local Language,” as it is usually in a local context. For purposes of description herein, domain names entered in Local Language shall be referred to as “Virtual Domain,” as they are not registered with the DNS but used for the convenience of users. For purposes of description herein, domain names in Roman Language shall be referred to as “Real Domain,” as they are used in the DNS.

The foregoing and objects are achieved by the present invention which allows Internet users to use both Roman Domain (Real Domain) and Local Domain (Virtual Domain) for a specific domain name under DNS. When an Internet user requests Virtual Domain, the Virtual Domain is transliterated into the corresponding Real Domain(s) in accordance with the conversion principles of the present invention. Then, the present invention navigates Internet using the converted Real Domain(s) and determines if any Internet sites of the Real Domain(s) exist. If there is one existing site, the existing site of the Real Domain is connected to and displayed at the user's computer. If there are more than one existing site, one of the existing sites is connected to and displayed at the user's computer. Certain information, such as title of the site, of the other existing sites is downloaded and listed in a list box or container of the user's computer. So, users can easily move to the other sites using the title information listed in the box by clicking the listed information, if they want to move. For example, when a local Internet user requests ‘ [symbol] a Local Domain, the present invention may transliterate the ‘ [symbol] into ‘www.yahoo.com’ and ‘www.yahu.com’ in accordance with the conversion principles of the present invention. Then the present invention navigates Internet using ‘www.yahoo.com’ and ‘www.yahoo.com’ and determines if ‘www.yahoo.com’ and ‘www.yahoo.com’ exist. If both of them exist, one site of the two, ‘www.yahoo.com’ for example, will be connected to and displayed at the user's computer. The title information of the other site, ‘www.yahoo.com’ of this example, will be listed in a list box of the user's computer. If the user wants to move to the site of ‘www.yahoo.com,’ he or she can easily do so by clicking the title information in the list box.

The present invention does not require additional registration for Local Domains as long as Roman Domains are registered. Also, Local Domains and Roman Domains are same in the current DNS system. Therefore, it does not require additional cost to build and maintain separate name servers or databases. The present invention will also eliminate many trademark problems. The access coverage of the present invention by Local Languages will be unlimited and global.

The conversion process of the present invention will be vice versa for the aforementioned Local DNS and Local Keyword systems. The present invention allows Roman Internet Users to access to Local DNS and Local Keyword systems by changing the conversion process of the present invention. Under such aforementioned local systems, a local domain is considered as a real domain, and a roman domain as a virtual domain. When a Roman Internet user requests a Roman virtual domain to access to the aforementioned local systems, the present invention transliterated the virtual Roman domain into a real local domain and connects the user's computer to the site of the real local Domain. The conversion process of the present invention will be explained mainly for DNS system, as the conversion process will be vice versa under the aforementioned local systems.

Real Domain names are typically in the form of ‘hostname.entityname.entitycode’ (e.g., ‘www.yahoo.com’) or ‘hostname.entityname.entitycode.countrycode’ (e.g., ‘www.yahoo.co.kr’). Virtual Domain names of the present invention basically duplicate the form of Real Domain names, but alphabets are Local Languages. For example, ‘ [symbol] of Korean Virtual Domain name is a replica of ‘www.yahoo.com’ of Real Domain name. The portion of ‘hostname’ is typically the name of the server host or cluster of server hosts connected to the Internet. The portion of ‘entityname’ is often the name of the entity that has the domain name. The portion of ‘entitycode’ is the organization code for the entity. In the example of ‘www.yahoo.com’ and ‘ [symbol] ‘www’ and ‘ [symbol] are the names of the server host (third-level domain); ‘yahoo’ and ‘ [symbol] are the names of the entity (second-level domain); and ‘com’ and ‘ [symbol] is the organization code for the entity (first-level domain).

The structure and conversion process of the present invention is briefly summarized below.

First, the present invention has knowledge bases for the phonemes of Local and Roman Languages. For each phoneme of Local Language, the knowledge bases are structured to set the priority among the corresponding alphabets of Roman Language matched by same or similar phonemes, based on the frequency and the importance of the Roman phonemes in Internet usage. The corresponding alphabets of Roman Language for each phoneme of Local Language may be individually numbered based on the set priority. For example, ‘ [symbol] of Korean phoneme may have four English alphabets matched by same or similar phoneme, such as ‘ka,’ ‘ga,’ ‘gar’ and ‘gha.’ Therefore, ‘ [symbol] ’ may be matched to ‘ka,’ ‘ [symbol] ’ to ‘ga,’ ‘ [symbol] ’ to ‘gar’ and ‘ [symbol] ’ to ‘gah.’ ‘ [symbol] of Korean phoneme may have three English alphabets matched by same or similar phoneme, such as ‘na,’ ‘nar’ and ‘nah.’ Therefore, ‘ [symbol] ’ may be matched to ‘na,’ ‘ [symbol] ’ to ‘nar,’ ‘ [symbol] ’ to ‘nah.’ In the case of ‘ [symbol] ’ which is the combination of ‘ [symbol] and ‘ [symbol] ‘ [symbol] ’ may be matched to ‘kana,’ ‘ [symbol] ’ to ‘kanar,’ ‘ [symbol] ’ to ‘gana,’ ‘ [symbol] ’ to ‘ganar,’ ‘ [symbol] ’ to ‘gahnah,’ and so on. The number ‘0’ may be considered as a default number. Therefore, ‘ [symbol] may be equal to ‘ [symbol] ,’ which is ‘kana’ of English phonemes.

Second, the present invention installed at users’ computers generates a unique encryption code depending on each Local Domain entered in Local Language. The unique encryption code generated at users’ computers contains information on Virtual Domain name entered by users and the type of Local Language. An administration server issues the same encryption code as generated at the user computer, and installs it at the Internet site of a Real Domain converted from the Virtual Domain. The encryption code issued by the administration server may be installed at the title section of the Internet site. The encryption code installed at the Internet site contains information on the Virtual Domain, the type of Local Language, the expiration date of the encryption code, the IP address of the server and other necessary information. This encryption code will be used to identify the Internet site of a specific Virtual Domain name among the sites of the various Real Domain name(s) converted from the Virtual Domain name. If the Virtual Domain name and the type of language information of the encryption code generated at users' computer match with the Virtual Domain name and the type of language information of the encryption code installed at an Internet site, the Internet site with the encryption code installed is considered as the Internet site of the specific Virtual Domain name. Then, the Internet site with the encryption code installed is connected to and displayed at the users' computers. The other existing Internet sites of the Roman Domain names converted from the Virtual Domain name, if any, will be listed in a list box. For example, as in the preceding paragraph, ‘www. [symbol] of Korean Virtual Domain name may have four converted Real Domain names; ‘www.ka.com,’ ‘www.ga.com,’ ‘www.gar.com’ and ‘www.gah.com.’ Assuming that only ‘www.ka.com’ and ‘www.gar.com’ have active Internet sites and that ‘www.gar.com’ has the encryption code for ‘www. [symbol] the Virtual Domain name entered by the user, the site of ‘www.gar.com’ is connected to and displayed at the user's computer. The title information of the ‘www.ka.com’ is listed in a list box or a container of the user's computer. The type of language information will be used as user's language preference and the contents of the site prepared in the user's preferred language, if any, will be displayed at the users' computers. The IP address information and expiration date information will be used to prevent any unauthorized move of the encryption code from the authorized IP server and unauthorized extension of the encryption code. For example, the encryption code installed at a server with a specific IP address will not work if the encryption code is moved to other server with different IP address.

Third, the present invention decomposes a Virtual Domain name and converts it to the Real Domain name(s) in accordance with the principles of the present invention. The coded portion of a Virtual Domain name such as entity code and country code is converted to the pre-assigned and equivalent words or codes of the Real Domain name. For example, ‘ [symbol] of a Virtual Domain name is converted to ‘.com’ and ‘ [symbol] of a Virtual Domain name is converted to ‘.co.kr.’

Fourth, using the knowledge bases of the present invention, the entity-defined portion of a Virtual Domain name is decomposed and transliterated to the entity-defined portion of Real Domain name(s) by converting alphabets of a Virtual Domain name to the phonemes of a Virtual Domain name, to the same or similar phonemes of Real Domain name(s), and to the alphabets of Real Domain name(s). The numbered priority may be used for this transliteration as explained in the preceding paragraph. For example, ‘ [symbol] and ‘ [symbol] ’ may be transliterated to ‘kana,’ while ‘ [symbol] ’ may be transliterated to ‘gana.’

Fifth, certain words, representing industries usually, of the entity-defined portions of a Virtual Domain name may be translated to the corresponding words of Real Domain name(s). For example, ‘ [symbol] of Korean word may be transliterated to ‘bank’ of English, ‘ [symbol] to ‘pharm’ and ‘ [symbol] ‘life’ and so on.

Sixth, the present invention applies certain weight factors to the converted Real Domain name(s) based on the frequency and the importance of the converted Roman phonemes in the Internet usage. The converted Real Domain name(s) will be listed from the most likely existing one to the least likely existing one.

Seventh, the present invention navigates Internet using the converted Real Domain name(s) from the most likely existing Real Domain name, which may have active Internet site, to the least likely existing one. From the navigation, the contents or certain information of the existing Real Domain(s), if any, will be displayed or listed. If a unique encryption code of the present invention is identified from the Internet site of an existing Real Domain name converted from a Virtual Domain, the contents of the Internet site will be displayed first. Certain information, such as title information, of the other existing Real Domain name(s) will be listed in a list box or a container so that users can click them and easily move to the listed sites. If no unique encryption code is identified from the existing Real Domain name(s), the Internet site of the first navigated Real Domain name will be displayed. The certain information, such as title information, of the other existing Real Domain name(s) will be listed in a special box or a container.

Eighth, the present invention has learning memories to record users' habits of Internet navigation. The learning memories contain information on Virtual Domain names entered by users, existing and non-existing Real Domain name(s) for each corresponding Virtual Domain name, the lastly visited site among the existing Real Domain name(s) and other necessary information, once a Virtual Domain name is navigated. When a user inputs a Virtual Domain name, the present invention first searches learning memories to find if the Virtual Domain name and the related existing Real Domain name(s) exist in the learning memories. If there is any existing Real Domain name(s) corresponding to the Virtual Domain name in the learning memories, the site of the existing Real Domain name(s) will be displayed or listed in a list box same as aforementioned. The learning memories may keep updated as users navigate Internet.

Ninth, the present invention sends information on the Virtual Domain name entered by users, Real Domain name(s) and other information to certain servers, as users enter domain names. The servers receiving such information have databases of the Internet sites similar to the Virtual Domains entered or the converted Real Domain(s). The receiving servers may send back to the users' computer the information of similar sites in business nature, the sites of competing companies, alternative product sites and other useful site information based on the Virtual Domain name entered and the Real Domain name(s) converted. Such similar site information will be listed in a box or a container so users can move to the similar sites easily by clicking them. This function of the present invention may be useful for aparture marketing or target marketing because users visiting to certain Internet sites are provided with the information on the sites of similar products, competing companies and other information. So he or she can move easily to the site of similar products or competing companies or organizations.

In summary, the Virtual Domain Name system of the present invention is an interfacing system between Local and Roman Domain names, identifying Local and Roman Domain name(s) based on one-to-one and one-to-many matching method. The present invention displays an existing Internet site of a Roman Domain name converted from the Virtual Domain name entered by users, and lists the existing site information of the other Roman Domain names. The present invention also lists similar sites such as the sites of the same industries, competing companies and similar products depending on the Virtual Domain name entered by users.

For Local DNS, Local Keyword or Meaningless Roman Domain systems, which registers Local Languages as domain names or keywords, the present invention allows Internet users to use both Local Domain and Roman Domain. In this situation, the transliteration will be in the other direction from Roman Domain names to Local Domain names. The present invention may make the Local DNS and other local Internet systems international, which can be accessed not only in Local Language but also in Roman language such as English.

The present invention may be implemented at the user's computer without having to change the DNS. The present invention may also be implemented at the server level without having to change the DNS. The present invention can be applied not only to the Internet domain names, but also to other Internet identifiers such as e-mail addresses, sub-directories and files. The present invention can also be extended to various Internet devices other than wired personal computers. The present invention can be embodied into wireless or mobile phones as well as telephones.

The present invention further applied to Internet appliances including, but not limited to, refrigerators and TV set-top box, which are manufactured for Internet accesses in addition to their traditional functions. The present invention can be applied to voice access to Internet as the present invention can convert Local Domain names entered by user's voice to Roman Domain names. The present invention can be further applied to dual search engines that search for both Local and Roman databases with one input either in Local or Roman. The present invention can be further applied to various database system or devices such as personal electric organizers or personal digital assistants (PDAs) and such kind as it can transliterate Local Languages to Roman Language or vice versa, or search for both Local Language and Roman Language queries with one input either in Local Language or English.

### BRIEF DESCRIPTION OF THE DRAWINGS

FIG. 1 shows the routing of domain name request and response in the DNS and a preferred arrangement of the present invention.

FIG. 2 shows the conversion process of a Virtual Domain name entered in Local Language into the corresponding Real Domain name(s) in English that comply with the DNS. It also shows the navigation of the Internet using the Real Domain name(s) and the display of the existing Internet sites at client computers.

FIG. 3 shows the conversion process of the coded portions of a Virtual Domain name entered in Local Language into the corresponding coded portions of Real Domain name(s) in English, with an example of Korean-to-English conversion.

FIG. 4 shows the conversion process of the entity-defined portions of a Virtual Domain name entered in Local Language into the corresponding entity-defined portions of Real Domain name(s) in English, with an example of Korean-English conversion.

FIG. 5 shows the conversion process of the entity-defined portion of a Virtual Domain name entered in Local Language into the corresponding entity-defined portion of Real Domain name(s) in English, using the phonemes of Local Language and English as a medium for the conversion of Local Language into English or vice versa.

### DETAILED DESCRIPTION OF THE INVENTION

Definitions

A user is anyone who uses the user host or computer, which is defined below.

A host is any computer attached to the Internet. A user host is a computer with which a user is connected to the Internet, and a server host is a computer that provides services to user hosts.

A local DNS server is a computer that holds a portion of the DNS database.

A root DNS server is a computer that keeps comprehensive information about IP addresses and the corresponding domain names in its domain.

An entity is any organization or individual that has a domain name registered with the DNS.

Alphabets are basic letters of a particular language system.

Description of Knowledge Bases and Numbering System

The present invention has knowledge bases for the phonemes of Local Language and Roman Language. For each phoneme of Local Language and Roman Language, the knowledge bases are structured to set the priority among the alphabets (or “letters” used interchangeably) of Roman Language based on the frequency and importance in Internet usage. The alphabets of Roman Language for each phoneme of Local Language may be individually numbered based on the set priority. The following table shows a brief example knowledge base.

| | 0 | 1 | 2 | 3 |
|---|---|---|---|---|
| [symbol] | Sam | Sarm | Psalm | |
| [symbol] | Sung | Seong | Seung | |
| [symbol] | Mall | Mol | Maul | Mole |
| [symbol] | Buy | Bi | By | Bye |

For example, ‘ [symbol] of Korean phoneme may have three English alphabets matched by same or similar phoneme, such as ‘sam,’ ‘sarm,’ and ‘psalm.’ Therefore, ‘ [symbol] ’ may be matched to ‘sam,’ ‘ [symbol] ’ to ‘sarm’ and ‘ [symbol] ’ to ‘psalm.’ ‘ [symbol] of Korean phoneme may have three English alphabets, such as ‘sung,’ ‘seong’ and ‘seung.’ Therefore, ‘ [symbol] ’ may be matched to ‘sung,’ ‘ [symbol] ’ to ‘seong,’ ‘ [symbol] ’ to ‘seung.’ ‘ [symbol] of Korean phoneme may have four English alphabets, such as ‘mall,’ ‘mol,’ ‘maul’ and ‘mole.’ Therefore, ‘ [symbol] ’ may be matched to ‘mall,’ ‘ [symbol] ’ to ‘mol,’ ‘ [symbol] ’ to ‘maul,’ and ‘ [symbol] ’ to ‘mole.’ ‘ [symbol] of Korean phoneme may have four English alphabets, such as ‘buy,’ ‘bi,’ ‘by’ and ‘bye.’ Therefore, ‘ [symbol] ’ may be matched to ‘buy,’ ‘ [symbol] ’ to ‘bi,’ to ‘ [symbol] ’ to ‘by,’ and ‘ [symbol] ’ to ‘bye.’ In the case of ‘ [symbol] which is the combination of ‘ [symbol] and ‘ [symbol] ‘ [symbol] ’ may be matched to ‘samsung,’ ‘ [symbol] ’ to ‘samseong,’ ‘ [symbol] ’ to ‘sarmsung’ and so on. The number ‘0’ may be used as a default number and, therefore, ‘ [symbol] may be the default form of ‘ [symbol] ’ which is matched to ‘samsung.’ ‘ [symbol] ’ will be matched to ‘samseongmall’ according to the above example knowledge base. ‘ [symbol] ’ will be matched to ‘byesamsung.’

For each phoneme of Local Language, numbers are matched to each corresponding alphabets of Roman Language matched by same or similar phoneme, based on the frequency and the importance in Internet usage. With this numbering system, the phonemes of Local Language may be uniquely matched to each corresponding alphabets of Roman Language by same or similar phoneme, based on one-to-one matching method.

Users may not use this numbering system as it is somewhat cumbersome. In this case, the phoneme of Local Language will be matched to several corresponding alphabets of Roman Language by same and similar phoneme, based on one-to-many matching method.

Description of Encryption Code

The encryption code of the present invention is a unique identifier among various Roman Domain names converted from a Virtual Domain name. The present invention installed at users' computers generates a unique encryption code depending on each Local Domain entered in Local Language. The unique encryption code generated at users' computers contains information on Virtual Domain name entered by users and the type of Local Language. An administration server issues the same encryption code as generated at the user computer, and installs it at the Internet site of a Real Domain converted from the Virtual Domain. The encryption code issued by the administration server may be installed at the title section of the Internet site. The encryption code installed at the Internet site contains information on the Virtual Domain, the type of Local Language, the expiration date of the encryption code, the IP address of the server and other necessary information.

When users enter a Virtual Domain name, the present invention installed at client computers generates an encryption code for the specific Virtual Domain name, navigates the various Real Domain names converted from the Virtual Domain name, and downloads the title information and the encryption code, if any, from the existing sites of the converted Roman Domain names. The present invention displays the contents of the Internet site with the encryption code installed. The title information of the other existing sites of the converted Roman Domain names, if any, will be listed in a list box or container.

For example, as in the preceding example knowledge base, ‘www. [symbol] of Korean Virtual Domain name may have four converted Real Domain names; ‘www.mall.com,’ ‘www.mol.com,’ ‘www.maul.com’ and ‘www.mole.com.’ Assuming that only ‘www.mall.com’and ‘www.mol.com’ have active existing Internet sites and that ‘www.mall.com’ has the encryption code for ‘www. [symbol] the Virtual Domain name entered by a user, the site of ‘www.mall.com’ is connected to and displayed at the user's computer. The title information of the ‘www.mol.com’ is listed in a list box or a container of the user's computer.

The type of language information will be used to determine user's language preference and the contents of the site prepared in the user's preferred language, if any, will be displayed at the users' computers. The IP address information and expiration date information will be used to prevent any unauthorized move of the encryption code from the authorized IP server and unauthorized extension of the encryption code. For example, the encryption code installed at a server with a specific IP address will not work if the encryption code is moved to other server with different IP address or if the expiration date is passed.

Description of Learning Memories

The present invention has learning memories at client computer to record users' habits of Internet usage. Once an user visits a Virtual Domain name, the learning memories record Virtual Domain names, existing and non-existing Real Domain name(s) converted from the Virtual Domain name entered by an user, the Real Domain name with encryption code installed, the lastly visited site among the existing Real Domain name(s) and other necessary information. When a user inputs a Virtual Domain name, the present invention searches for the same Virtual Domain name in the learning memories. If the Virtual Domain name is found from the learning memories, the present invention connects to the Real Domain name(s). The present invention connects to the Real Domain name with encryption code installed, if found. The present invention connects to the Real Domain name lastly visited, if no encryption code is found. The certain information of the other existing Real Domain name(s) will be listed in a list box or container. If the Virtual Domain name is not found from the learning memories, the present invention performs the routine procedures, which navigate the Real Domain name(s) converted from the Virtual Domain name. The learning memories may keep updated as users navigate Internet.

Description of Conversion Process

The present invention decomposes the Virtual Domain name entered by users and converts it to the most likely existing Real Domain name(s) using the knowledge bases.

The conversion process of the present invention incorporates two conversion processes. The first process is to convert the coded portions of domain names such as organization codes, geographic regional codes, and country codes. In this process, each real coded portion in English is pre-assigned a virtual equivalent word or code in the local language based upon the meaning or the pronunciation of the real coded portion in English. Then, the virtual equivalent word or code entered in Local Languages is converted into the corresponding real coded portion in English. The second conversion process is to convert the entity-defined portion of the Virtual Domain name such as organization names, brand names, trademarks, and server host names. In this process, the present invention decomposes the entity-defined portion of the Virtual Domain name by pronunciation and transliterates it to the possible entity-defined portion of the Real Domain name(s) using the knowledge bases of the present invention. As the knowledge bases are structured based on the frequency and the importance in Internet usage of Roman Language alphabets matched by the same or similar phoneme to the Local Language phoneme, the transliterated entity-defined portion of Real Domain name(s) will be in the order of high frequency and importance of the converted Roman phonemes in Internet usage. Certain words, representing industries usually, of the entity-defined portions of a Virtual Domain name may be translated to the corresponding words of Real Domain name(s). This decomposing, transliteration and translation process will be performed until all the phonemes of the Virtual Domain names are converted to Real Domain name(s). Weight factors are applied to the Real Domain name(s) converted from a Virtual Domain name and list the weighted Real Domain names from the highest possibly existing one to the last possibly existing one.

The first conversion process of the present invention converts the coded portions of Virtual Domain name entered in the Local Language into the corresponding coded portions of Real Domain names in Roman Language. For this conversion, each of the coded portions of Real Domain names in Roman Language (i.e., first-level domain codes in the United States, and first-level and second-level domain codes in the other countries) is pre-assigned equivalent codes or words of Virtual Domain in Local Language. The codes or words of Virtual Domain have the same meaning or pronunciation in Local Language as its corresponding codes of Real Domain in Roman. Domain names in each country other than the United States have second-level domain codes (i.e., organization codes and geographic regional codes) directly under a first-level domain code (i.e., country code). For example, for users who want to visit server hosts in the U.S. using Virtual Domain names in Korean, the first conversion process matches the seven first-level domain codes (i.e., organization codes) used in the U.S. with their virtual equivalents in Korean. Each of the first-level codes of Real Domain names in English can be pre-assigned the equivalent first-level codes of Virtual Domain in Korean as follows: ‘.com’=‘. [symbol] ‘.edu’=‘. [symbol] ‘.gov’=‘. [symbol] ’ ‘.int’=‘. [symbol] ’ ‘.mil’=‘. [symbol] ’ ‘.net’=‘. [symbol] and ‘.org’=‘. [symbol] ’ These words in Korean have the same pronunciation in Korean as their equivalents in English, and Korean users can use them unambiguously in the local context. This is just one example of the pre-assigned first-level codes of Virtual Domain in Korean. Other words in Korean, which have same meaning as the equivalents of Real Domain, can be pre-assigned. For example, ‘.com’ of Real Domain can be ‘. [symbol] and ‘.edu’ can be ‘. [symbol] Also, for users who want to visit server hosts in Korea using Virtual Domain names in Korean, the first conversion process matches in the same way the second-level domain codes used in Korea with pre-assigned virtual equivalents in Korean. In this case, the first-level domain code ‘.kr’ (i.e., the country code for Korea) can be matched with a virtual equivalent ‘. [symbol] in Korean. For users who want to visit server hosts in other countries using Virtual Domain names in Korean, the first conversion process matches in the same way the first-level domain codes (i.e., country codes) and each country's second-level domain codes with pre-assigned virtual equivalents in Korean.

The second conversion process of the present invention converts the entity-defined portions of a Virtual Domain name entered in Local Language into the corresponding entity-defined portions of Real Domain(s) in Roman Language. This process uses the phonemes of Local Language and Roman Language as a medium for the conversion. Phonemes are the units of the sound system of a language, and they approximate closely to the sounds represented by the letters used. When users enter an entity-defined portion of Virtual Domain in Local Language, the present invention transliterates it into the corresponding entity-defined portion of Real Domain in Roman Language using the knowledge bases of the present invention. The knowledge bases are composed of Local Language alphabets and corresponding Roman Language alphabets, which are matched, based on the same or proximate phonemes of Local Language and Roman Language. First, based upon the knowledge bases, the entity-defined portion of a Virtual Domain entered in Local Language is decomposed into individual alphabets or sets of alphabets so that each individual alphabets or set of alphabets can represent an individual phoneme of Local Language. Second, each individual phoneme of Local Language is matched with an equivalent Roman phoneme that has the same or proximate sound. Third, based upon the standard pronunciation of Roman Language, each Roman phoneme is represented by an alphabet or set of alphabets in Roman. Fourth, all the alphabets or sets of alphabets in Roman are united to compose the corresponding entity-defined portion of Real Domain name in Roman Language. The resulting entity-defined portion of Roman Domain names would be pronounced as the same or almost the same as the entity-defined portion entered in Local Language, since both represent the phonemes that have the same or proximate sounds. Thus, it is easy for the user to deduce the entity-defined portion of a Virtual Domain name in Local Language that corresponds to the entity-defined portion of Real Domain in Roman Language. There may be more than one entity-defined portions of Real Domain corresponding to one entity-defined portion of Virtual Domain because there may be several proximate phonemes of Roman Language corresponding to a phoneme of Local Language.

In the following example, Korean is taken as an example of Local Language and English as Roman Language. The following example knowledge base shows how the Korean alphabets are matched with English letters by phoneme. The Korean alphabet ‘ [symbol] may have four corresponding sets of English alphabets such as ‘mall,’ ‘mol,’ ‘maul’ and ‘mole’ matched by the same or proximate phoneme. The example knowledge base is structured to set the priority among the corresponding sets of English alphabets based on the frequency and importance in Internet usage. The ‘mall’ of the four alternatives is considered as the most popular set of English alphabets used in Internet corresponding to the Korean alphabet ‘ [symbol] Some sets of English alphabets are the English sets of alphabets transliterated from original Korean alphabets in accordance with the customary transliteration method. The ‘mol’ of the four alternatives is one of the transliterated Korean alphabet, which is ‘ [symbol] in Korean, in accordance with the customary Korean-to-English transliteration method. The corresponding English phonemes to each Korean phoneme may be individually numbered based on the priority.

| | 0 | 1 | 2 | 3 |
|---|---|---|---|---|
| [symbol] | Sam | Sarm | Psalm | |
| [symbol] | Sung | Seong | Seung | |
| [symbol] | Mall | Mol | Maul | Mole |
| [symbol] | Buy | Bi | By | Bye |
| [symbol] | Good | Gut | Goot | |
| [symbol] | Good | Gut | Goot | |

‘ [symbol] of Korean has the same or proximate phoneme as ‘sam,’ ‘sarm’ or ‘psalm’ of English.
‘ [symbol] of Korean has the same or proximate phoneme as ‘sung,’ ‘seong’ and ‘seung’ of English.
‘ [symbol] of Korean has the same or proximate phoneme as ‘mall,’ ‘mol,’ ‘maul’ and ‘mole’ of English.
‘ [symbol] of Korean has the same or proximate phoneme as ‘buy,’ ‘bi,’ ‘by’ and ‘bye’ of English.

Since there are more than one English alphabet matched by the same or proximate phoneme for a corresponding Korean phoneme, the entity-defined portion of a Korean domain name can be transliterated into more than one entity-defined portion of English domain names. Therefore, the transliteration of the entity-defined portion of Virtual Domain to that of Real Domain will be the one-to-many transliteration method. The resulting entity-defined portions of English will be listed by the order of the set priority. For example, ‘ [symbol] of Korean alphabets will be transliterated into nine English alphabets by matching phonemes, and will be listed in the order of the set priority as follows; ‘samsung,’ ‘samseong,’ ‘samseung,’ ‘sarmsung,’ ‘sarmseong,’ ‘sarmseung,’ ‘psalmsung,’ ‘psalmseong’ and ‘psalmseung.’

In order to transliterate in one-to-one method, the virtual numbers may be used. The corresponding English alphabets for each phoneme of Korean may be individually numbered based on the set priority. When a Virtual Domain is entered with the virtual numbers, the entity-defined portion of the Virtual Domain will be transliterated in one-to-one matching method. For example, ‘ [symbol] ’ will be matched to ‘sam,’ ‘ [symbol] ’ to ‘sarm’ and ‘ [symbol] ’ to ‘psalm.’ ‘ [symbol] ’ will be matched to ‘sung,’ ‘ [symbol] ’ to ‘seong,’ ‘ [symbol] ’ to ‘seung.’ ‘ [symbol] ’ will be matched to ‘mall,’ ‘ [symbol] ’ to ‘mol,’ ‘ [symbol] ’ to ‘maul,’ and ‘ [symbol] ’ to ‘mole.’ ‘ [symbol] ’ will be matched to ‘buy,’ ‘ [symbol] ’ to ‘bi,’ ‘ [symbol] ’ to ‘by,’ and ‘ [symbol] ’ to ‘bye.’ In the case of ‘ [symbol] which is the combination of ‘ [symbol] and ‘ [symbol] will be matched to ‘samsung,’ ‘ [symbol] ’ to ‘samseong,’ ‘ [symbol] ’ to ‘sarmsung’ and so on. The number ‘0’ may be used as a default number and, therefore, ‘ [symbol] may be the default form of ‘ [symbol] ,’ which is matched to ‘samsung.’ ‘ [symbol] ’ will be matched to ‘samseongmall.’ ‘ [symbol] ’ will be matched to ‘byesamsung.’

Many Real Domain names in English also have acronyms, abbreviations or initials within their entity-defined portions. When an acronym, abbreviation or initial is used as a part of or an entire real entity-defined portion in English, the second conversion process of the present invention matches each individual sets of letters of Korean with the corresponding letters of English in accordance with customary or common transliteration of individual English letters in Korean. For example, English letters ‘i,’ ‘b’ and ‘m’ in ‘ibm’ are transliterated into ‘ [symbol] ’ ‘ [symbol] and ‘ [symbol] in Korean, respectively. So, a Korean entity-defined portion [symbol] of Virtual Domain can be transliterated into an English entity-defined portion ‘ibm’ of Real Domain. Also, the same entity-defined portion ‘ [symbol] of Virtual Domain entered in Korean can be transliterated into ‘aibiaem’ or ‘eyebm’ or some other combination of phonemes in English in accordance with customary and common transliteration of Korean into English.

The present invention is a fuzzy system for Internet users to enter Virtual Domain in different alphabets of Local Language for the same phonemes of Roman Language. For a Korean example, [symbol] and ‘ [symbol] are different in alphabets of Local Language but have same phonemes of English as shown in the above example knowledge base. So, when Korean Internet users enter either ‘ [symbol] or ‘ [symbol] the present invention can transliterate them to ‘good,’ ‘gut,’ and ‘goot’ in same. This function of the present invention is very useful for Internet users of Local Language because many of them do not know the exact alphabets of Local Language for corresponding words of Roman Language.

Many Internet users of Local Language may include words representing their industries in the entity-defined portion as a part. For example, banks include ‘bank’ in the entity-defined portion of their Real Domain and life insurance companies include ‘life.’ In the meantime, such industries are usually expressed using meaningful words of Korean, which may have different phonemes of English. For example, ‘bank’ of English is translated into ‘ [symbol] of Korean, one of whose English phonemes is ‘eunhaening,’ which has different pronunciation from ‘bank.’ Such industry words of Local Language may be translated into words of Roman Language in the conversion process of the entity-defined portion. For example, ‘ [symbol] of Korean may be converted into the following English; ‘shinhanbank’ and ‘shinhaneunhaeng.’

The conversion process of the present invention allows the user to enter a domain name mixed with letters in the local language and English, since the conversion takes place on each individual portion of the domain name and each individual alphabet or set of alphabets of the portion. A user may prefer to enter some portions of a domain name in Roman Language, while entering the other portions of the domain name in Local Language. In this case, the portions entered in Roman Language pass over the conversion process, and only the portions entered in Local Language go through the conversion process. For example, a Korean user can enter ‘alpha. [symbol] co.kr’ to access the server host whose real domain name in English is ‘alpha.samsung.co.kr.’ Then, only the portion ‘ [symbol] entered in Korean is converted into the corresponding portion ‘samsung’ in English in accordance with the principles of the present invention, and the other portions, ‘alpha,’ ‘co’ and ‘kr’ entered in English, pass over the conversion process. The conversion system of the present invention also allows the user to enter even an entity-defined portion mixed with letters in the local language and English. For example, a Korean user can enter ‘www.ibm [symbol] com’ to access the server host whose real domain name in English is ‘www.ibmcomputer.com.’ Then, only the part ‘ [symbol] entered in Korean is converted into the equivalent ‘computer’ in English in accordance with the principles of the present invention, while the remaining parts of the entity-defined portion and the other portions pass over the conversion process.

The conversion system of the present invention allows the user to enter other identifiers used on the Internet in the local language, such as user IDs of e-mail addresses, names of directories and subdirectories, names of Web pages and files, keywords used in search engines and directory services, and so on. For example, a virtual e-mail address ‘ [symbol] entered in Korean is converted into the corresponding real e-mail address ‘chunwonho@hotmail.com’ in English, as ‘ [symbol] ’ ‘ [symbol] and ‘ [symbol] in Korean are matched with ‘chunwonho,’ ‘hotmail’ and ‘com’ in English, respectively, in accordance with the principles of the present invention. Also, the virtual third-level domain name, ‘ [symbol] can be converted to the real third-level domain name ‘manhwa.chosun.com,’ as ‘ [symbol] and ‘ [symbol] are transliterated into ‘manhwa’ and ‘chosun,’ respectively. Also, a virtual Web page name ‘www. [symbol] html,’ which are mixed with Korean and English letters, is also converted into the corresponding real Web page name ‘www.yahoo.co.kr/hoegye/ibmun.html’ in English, as ‘ [symbol] ‘ [symbol] ’ ‘ [symbol] ’ ‘ [symbol] and ‘ [symbol] in Korean are matched with ‘yahoo,’ ‘co,’ ‘kr,’ ‘hoegye,’ and ‘ibmun’ in English, respectively, in accordance with the principles of the present invention. Also, a virtual keyword ‘ [symbol] entered in Korean is matched with the corresponding real keyword ‘computer’ in English, as the word ‘ [symbol] in Korean is matched with the word ‘computer’ in English in accordance with the principles of the present invention.

Detailed Description of Figures

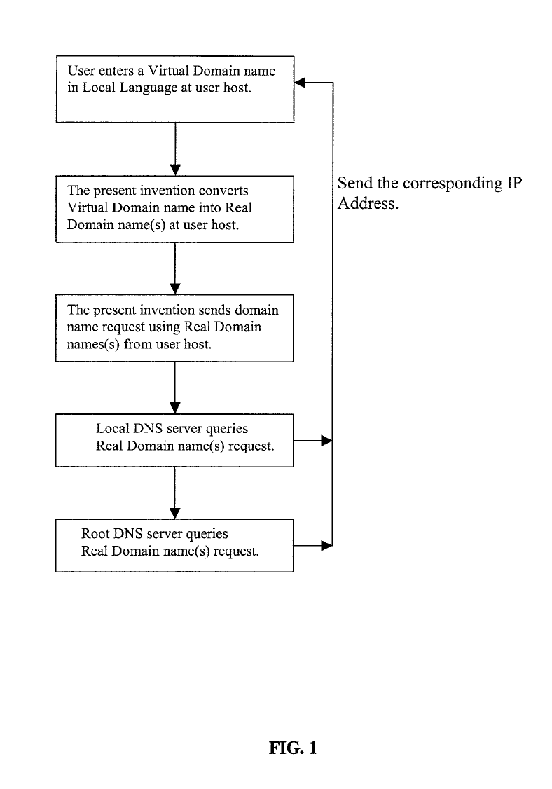

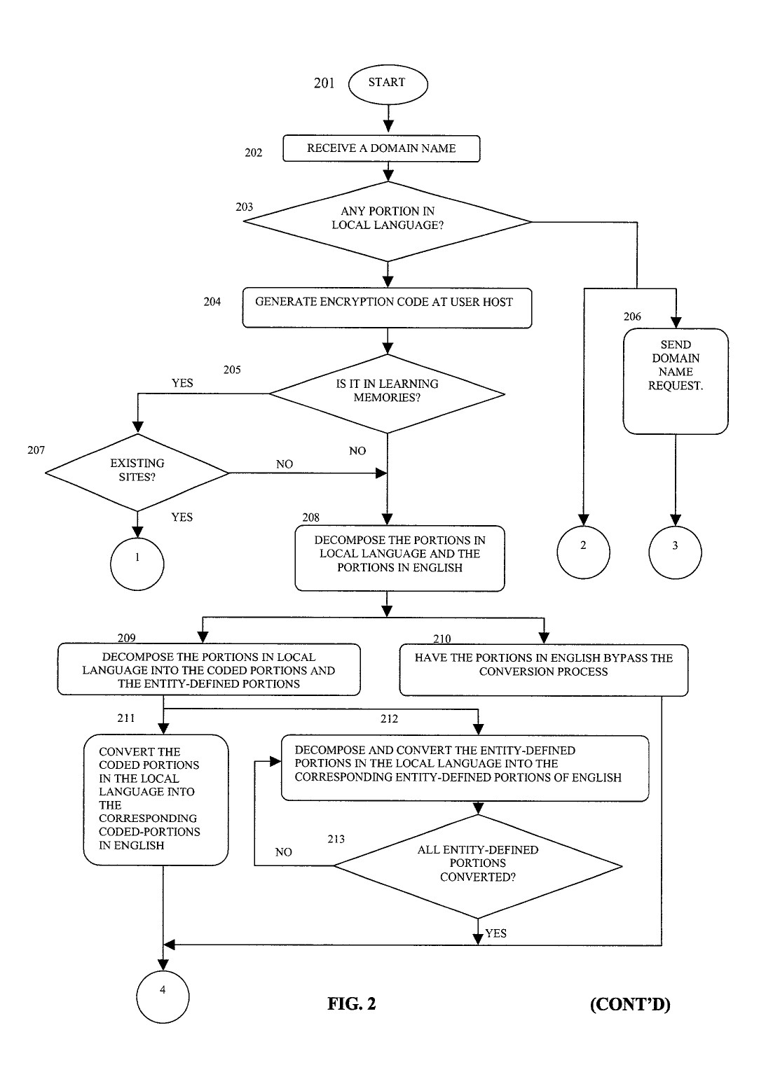

FIG. 1 shows the routing of domain name request and response in the DNS and a preferred arrangement of the present invention. First, the user enters a Virtual Domain name in Local Language at the user's host. Second, the present invention converts the Virtual Domain name into the corresponding Real Domain name(s) in English, which are fully compatible with the current DNS system. Third, the user host sends the converted Real Domain name(s) request to its local DNS server for the domain name(s) of the server host for which it needs the corresponding IP address. The local DNS server keeps track of domain names and the corresponding IP addresses of its designated group of hosts or clusters of hosts. Fourth, the local DNS server queries the domain name in its file. If the local DNS server recognizes the domain name in its file, it sends the corresponding IP address back to the user host. If not, the local DNS server passes the request on to the nearest root DNS server. There are currently about thirteen root DNS servers that keep comprehensive information of domain names and the corresponding IP addresses in their respective domain on the Internet. If the root DNS server recognizes the domain name in its file, it sends the corresponding IP address back to the local DNS server, which in turn sends the IP address back to the user host. Then, using the IP address following the TCP/IP protocol, a connection is established between the user host and the server host to which the user requests an access. This routing process of domain name request and response takes place automatically and is completely transparent to the user. In a preferred arrangement, the conversion system of the present invention is implemented at the user host before the domain name request is sent to the local DNS server.

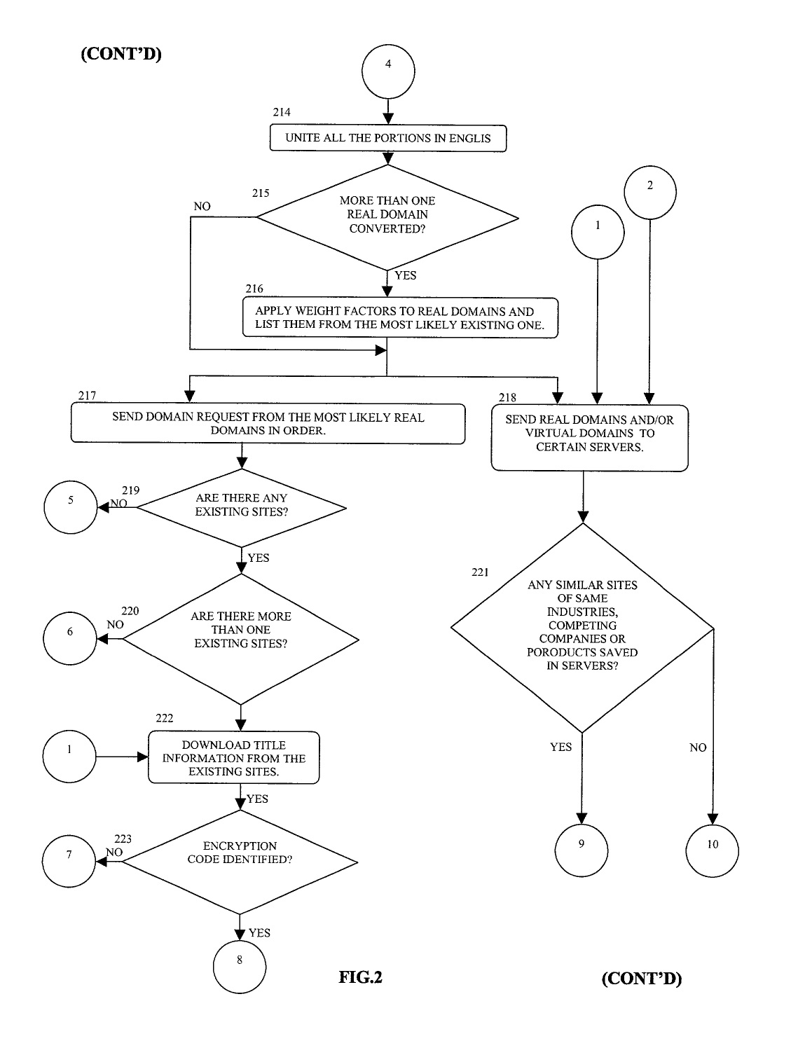

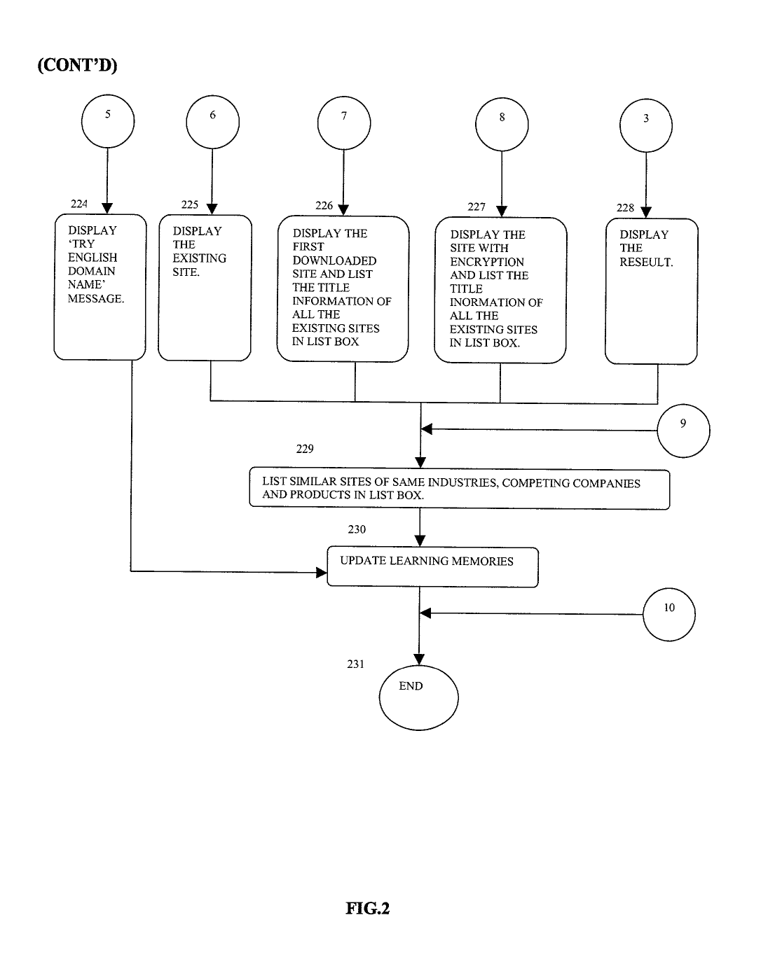

FIG. 2 illustrates the process of conversion of a Virtual Domain name entered in Local Language into the corresponding Real Domain name(s) in English that comply with the DNS. FIG. 2 also shows the Internet navigation and the display of the accessed Internet site at the user computer. The conversion system installed at the user host starts at step (201) and receives a domain name entered by the user. (202) The domain name can be entered in the Local Language in its entirety, English in its entirety, or a combination of letters in the local language and English.

The conversion process includes an inquiry into whether any portion of the domain name is in Local Language. (203) If the entire domain name is in English, the domain name does not need any conversion, and so, it bypasses the conversion process and the present invention sends domain name request directly. (206) The Internet site of the English domain name, if any, will be displayed at the user's computer. (228) The present invention also sends the English domain name to certain servers, which will send back similar site information and list it at the user's computer. (218 and 229) For example, if the user enters ‘www.samsungmall.com,’ the English domain bypasses the conversion process. The Internet site of ‘www.samsungmall.com’ will be displayed at the user's computer and the similar sites to ‘www.samsungmall.com,’ such as ‘www.lotte.com,’ will be listed, if any such site information is stored at the receiving servers.

If any portion of the domain name entered by the user is in Local Language, the present invention generates the unique encryption code for the entered Virtual Domain name. (204) Then, the conversion process makes another inquiry into whether the entered Local Domain name exists in the learning memories of the present invention. (205) For example, the user enters ‘www. [symbol] and the present invention first determines if ‘www. [symbol] exists in the learning memories. The learning memories keep Virtual Domain names and Real Domain names as the user navigates Internet. Then, the present invention determines if there is any existing sites of Real Domain names corresponding to ‘www. [symbol] (207) For example, if the Real Domains ‘www.samsungmall.com’ and ‘www.samseongmall.com’ exist for the ‘www. [symbol] in learning memories, the present invention downloads title information from ‘www.samsungmall.com’ and ‘www.samseongmall.com.’ (222) The present invention also sends ‘www. [symbol] ’ ‘www.samsungmall.com’ and ‘www.samseongmall.com’ to certain servers for similar site information. (218) The remaining process will be the same from that point.

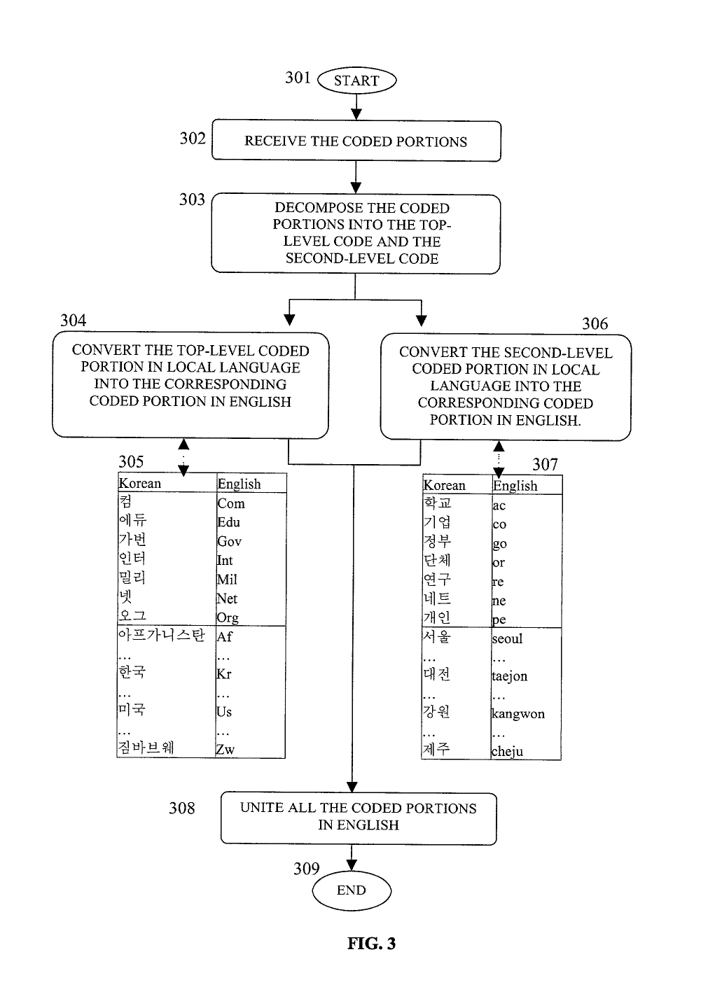

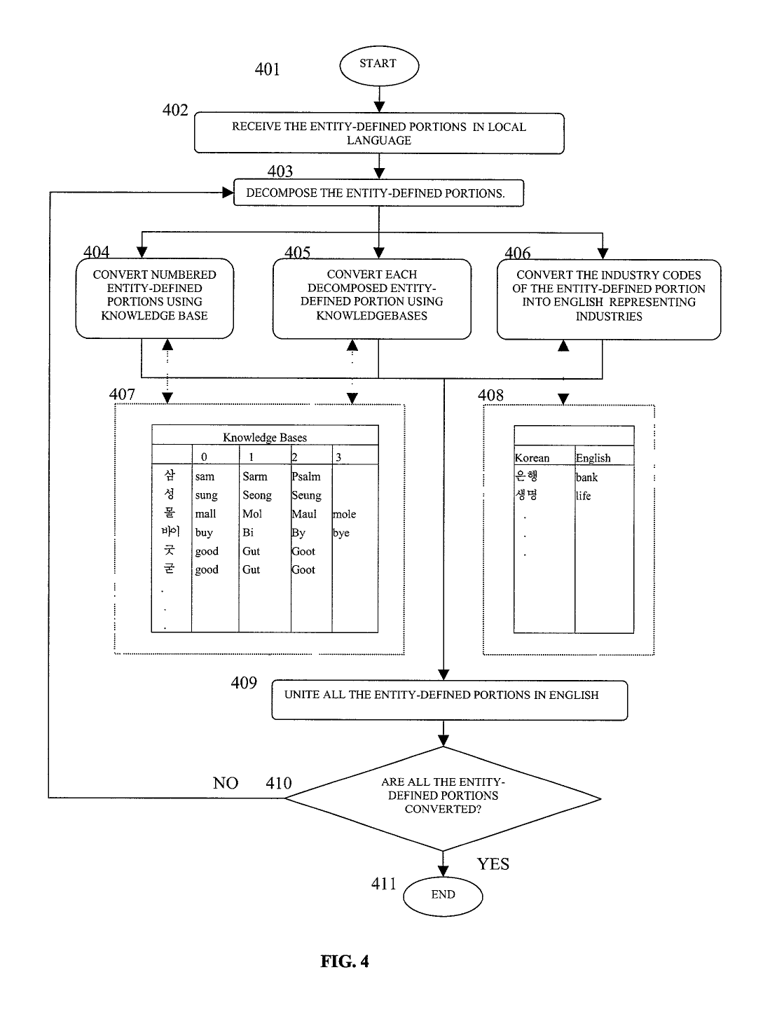

If ‘www. [symbol] does not exist in learning memories, which means that ‘www. [symbol] is first entered in the conversion system, the present invention decomposes it. (208) The ‘www. [symbol] will be decomposed into two portions, ‘www’ (210) and ‘ [symbol] ’ (209) Then, the ‘www’ portion will bypass the conversion process as it is English. (210) The ‘ [symbol] will be further decomposed into the coded portion, ‘ [symbol] and the entity-defined portion, ‘ [symbol] ’ The coded portion, ‘ [symbol] will be converted into ‘com’ as FIG. 3 shows. (211) The entity-defined portion, ‘ [symbol] will be converted into many Real Domain names using the example knowledge base as FIG. 4 shows. (212) The converted entity-defined portions for ‘ [symbol] will be ‘samsungmall,’ ‘samseongmall’ and other various phoneme combinations to ‘psalmseungmaul.’ The conversion process of the entity-defined portions will be performed until all entity-defined portions of Local Language are completed. (213) After all decomposed portions are converted, the present invention unite all the converted portions and list them. (214) For a Local Domain ‘www. [symbol] , many Real Domain names are united such as ‘www.samsungmall.com,’ ‘www.samseongmall.com,’ ‘www.samseungmall.com’ and so forth to ‘www.psalmseungmaul.com.’ If there are more than one converted Real Domain name, the present invention list them from the most likely existing Real Domain to the least likely one. (215 and 216) The knowledge bases of the present invention are structured by priority based on the frequency and the importance of the related phonemes and English alphabets. In addition, weight factors are applied to the converted Real Domains to set the order from the most likely existing Real Domain to the least one. (216) One simple example of such weight factors is shown in the following Virtual Domain name and corresponding converted Real Domain names. The Real Domain names ‘www.cinepark.com’ and ‘www.sinepark.com’ may be the two converted domain names for a Virtual Domain name ‘www. [symbol] . Since the Local Language ‘ [symbol] may have the same phoneme as the ‘cine’ and the ‘sine’ of English, ‘ [symbol] may be converted to ‘cine’ and ‘sine.’ However, higher weight factor will be applied to ‘www.cinepark.com’ than ‘www.sinepark.com’ because ‘cine’ and ‘park’ are originated from the same language source, English while ‘sine’ may represent an English transliteration of Korean ‘ [symbol] and ‘park’ is originated from English.

After the Virtual Domain name is converted to the Real Domain names and listed in order, the present invention sends the domain name request for a certain number of Real Domain names from the most likely existing one. (217) It is assumed that ‘www.samsungmall.com,’ ‘www.samseongmall.com’ and ‘www.samseungmall.com’ are sent for domain name request. Also, ‘www. [symbol] ’ ‘www.samsungmall.com,’ ‘www.samseongmall.com’ and ‘www.samseungmall.com’ will be sent to certain servers for similar site information request. (218)

After the domain name requests, the present invention will determine if there is any domain names returned. (219) For example, if none of ‘www.samsungmall.com,’ ‘www.samseongmall.com’ and ‘www.samseungmall.com’ returns domain name request, the present invention displays an error message such as ‘Try English Domain Name’ (224) and updates the learning memories that the Virtual Domain name ‘www. [symbol] does not exist. (230)

Assuming that a domain name request is returned for the ‘www.samsungmall.com’, the present invention displays the Internet site of the ‘www.samsungmall.com.’ (220 and 225)

If two domain name requests are returned for the ‘www.samsungmall.com’ and the ‘www.samseongmall.com,’ the present invention downloads the title information of the ‘www.samsungmall.com’ and the ‘www.samseongmall.com’ sites. (220 and 222) Then, the present invention determines if one of the two has the unique encryption code for the ‘ [symbol] from the title information downloaded, which is same as the encryption code generated at the user's computer by the present invention for ‘ [symbol] ’ (223) Assuming that none of ‘www.samsungmall.com’ and ‘www.samseongmall.com’ has the unique encryption code, the present invention will display the Internet site of ‘www.samsungmall.com’ and lists the title information of both ‘www.samsungmall.com’ and ‘www.samseongmall.com.’ because the ‘www.samsungmall.com’ is the first one sent for the domain name request. (226) If the ‘www.samseongmall.com’ has the unique encryption code for the ‘ [symbol] the present invention displays the Internet site of the ‘www.samseongmall.com’ and lists the title information of both ‘www.samseongmall.com’ and ‘www.samsungmall.com.’ (227)

If there is any similar site information stored in the servers, the servers send back to the user's computer the similar site information and list it in the list box together. (229) For example, if ‘www.lotte.com’ is stored as a similar site for ‘www.samsungmall.com,’ the servers send the information for ‘www.lotte.com’ and list it in the list box of the user's computer. So, the user can easily move to the Internet site of ‘www.lotte.com’ if he or she wants.

After all of navigation and display are completed, the learning memories of the present invention will be updated. The Virtual Domain name, the converted Real Domain names, the encryption information and other information will be updated at the user's computer so the user can access faster to the same Virtual Domain name when he or she access to the same site for the second time. (230) After the update of the learning memories, the process of the present invention is completed. (231)

FIG. 3 illustrates the process of conversion of virtual coded portions entered in Local Language into the corresponding real coded portions in English, with an example of Korean-to-English conversion. The first conversion method of the conversion system starts when the domain name entered by the user contains any coded portions in Local Language. (301) It receives the virtual coded portions in Local Language (302). The virtual coded portions in Local Language are decomposed into the top-level coded portion and the second-level coded portion (303). The virtual top-level coded portion in the local language is converted into the corresponding real top-level code in English (304). Box (305) shows some examples of the real top-level codes in English and their corresponding virtual words in Korean that are pre-assigned and entered by the user. The virtual second-level coded portion in Local Language is also converted into the corresponding real second-level code in English (306). Box (307) shows some examples of the real second-level codes in English and their corresponding virtual words in Korean that are pre-assigned and entered by the user. All the coded portions, which are now converted into English, are united together (308) and sent to step 211 in FIG. 2. The first conversion process of the conversion system ends at step (309).

FIG. 4 illustrates the conversion process of virtual entity-defined portions entered in Local Language into the corresponding real entity-defined portions in English, with an example of Korean-English conversion. The second conversion process of the present invention starts when the domain name entered contains any entity-defined portions in Local Language (401). It receives the virtual entity-defined portions in Local Language (402). The virtual entity-defined portions in Local Language are decomposed into individual entity-defined portion (403). Each individual virtual entity-defined portion in Local Language is converted into the corresponding real entity-defined portion in English (404 and 405) using the knowledge bases of the present invention. The numbered Virtual Domain name will be converted to the Real Domain name based on one-to-one matching method. (404) For example, ‘ [symbol] ’ may be converted to ‘samsung’ based on the example knowledge base. ‘ [symbol] is the default form of ‘ [symbol] ’ so ‘ [symbol] will be converted to ‘samsung.’ The Virtual Domain names without numbers will be converted to Real Domain names based on one-to-many matching method. (405) For example, the Korean Virtual Domain name ‘ [symbol] will be converted to several Roman Domain names, such as ‘goodbuy,’ ‘goodbi,’ ‘goodby,’ ‘goodbye’ and so on. Some Virtual Domain name contains words representing industries. (406) For example, most Korean banks include ‘bank’ in their domain names while the Korean word ‘ [symbol] ’ which is pronounced like ‘eun haeng,’ represents the bank industry. So, ‘ [symbol] an example Virtual Domain of a Korean bank will be converted to ‘bank.’ (407) and (408) are example knowledge bases. After the decomposed portions of the entity-defined portion are converted to English, the converted English portions are united. (409) This conversion process will be performed until all the virtual entity-defined portions are completely converted. (410) All the converted and united English Real Domains are sent to step 212 in FIG. 2. The second conversion process of the conversion system ends at step (411).

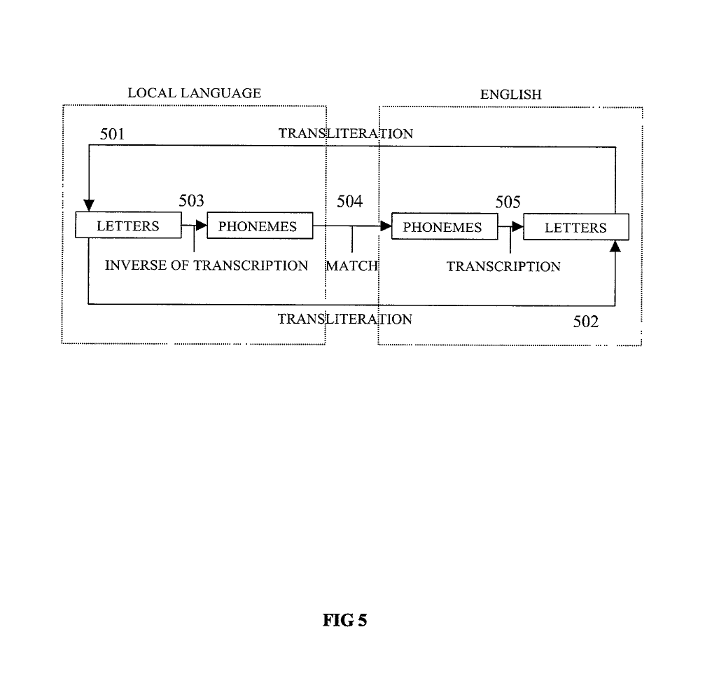

FIG. 5 shows the conversion process of a virtual entity-defined portion entered in Local Language into the corresponding real entity-defined portion in English or vice versa, using the knowledge bases of the present invention matched by the same or proximate phonemes of Local Language and English as a medium for the conversion. English can be transliterated into Local Language based on the knowledge bases of the present invention, which match Local Language alphabets with English alphabets by the same or proximate phonemes. (501) Local Language can be inversely transliterated into English in the same way. (502) The present invention converts the virtual entity-defined portion in Local Language into the corresponding real entity-defined portion in English in the following steps. First, the virtual entity-defined portion entered in Local Language is decomposed into individual alphabets or sets of alphabets so that each individual alphabets or set of alphabets can represent an individual phoneme of Local Language, which is the inverse of transcription of phonemes of Local Language into alphabets in Local Language. (503) Second, each individual phoneme of Local Language is matched with an equivalent English phoneme that has the same or proximate sound. (504) Third, based upon the customary pronunciation of English, each English phoneme is transcribed into the corresponding alphabets or set of alphabets in English (505). In either case, all the alphabets or sets of alphabets converted into English are united to compose the corresponding real entity-defined portion in English.

The Navigation, Encryption, Learning Memories, Display and List Box of the Present Invention

After a Virtual Domain name is converted to Real Domain name(s) in accordance with the conversion principles of the present invention, the present invention navigates Internet using the converted Real Domain name(s).

When Internet users enter a numbered Virtual Domain name as explained above, the Virtual Domain name will be converted to a Real Domain name based on one-to-one matching method. Then, the present invention will navigate Internet using the converted Real Domain because there is only one Real Domain at the end of the conversion in accordance with the principles of the present invention. After the navigation using the converted Real Domain, the Internet site of the converted Real Domain will be displayed at the monitor of the Internet user's computer if an active site is available for the converted Real Domain.

When Internet users enter a Virtual Domain without numbers, the Virtual Domain will be converted to many Real Domain names based on one-to-many matching method because there may be many phonemes of Roman Language for one Local Language as explained before. The Roman Domain names converted from the Virtual Domain name will be listed in the order from the highest possibly existing Real Domain to the least possibly existing Domain using the set priority of the knowledge bases and weight factors applied to the converted Roman Domain names. Then, the present invention navigates the converted Roman Domain names in the order of the list from the highest possibly existing Real Domain to the least possibly existing one.

Different weight factors are applied depending on different type of knowledge bases and the combination of converted phonemes. For example, if two phonemes are converted and combined to make several Real Domain names, weight factors are applied to each converted Real Domain as follows. ‘ [symbol] of Korean Virtual Domain can be converted to ‘buycar.com’ or ‘buyka.com’ or some other combination of phonemes of [symbol] and ‘ [symbol] In this case, ‘buycar.com’ may have higher weight factor than ‘buyka.com’ because both ‘buy’ and ‘car,’ which are the decomposed phonemes of ‘buycar,’ are transliterated from the same kind of language, English in this case. In the meantime, ‘buyka.com’ may have lower weight factor because ‘buy’ and ‘ka’ are converted from different type of language. As it is expected that the phonemes of the same language can be combined better, higher weigh factors are generally applied to the combination of phonemes from the same kind of language. There may be some other considerations in applying weight factors than the source of language. Such considerations, if any, can be incorporated into this weight factor system. By applying such weight factors, the present invention can navigate the converted Real Domains from the highest possibly active one to the least one.

The present invention generates encryption codes to identify the converted Real Domain names in one-to-one matching method. When Internet users enter a Virtual Domain without numbers, the Virtual Domain will be converted to many Real Domain names based on one-to-many matching method because there may be many phonemes of Roman Language for a corresponding phoneme of Local Language. The encryption code method of the present invention is a method to uniquely identify one Internet site of a Roman Domain name among the various Roman Domain names converted from a Virtual Domain name. The present invention installed at client's computer generates a consistent encryption code depending on the specific Virtual Domain name entered in Local Language by users. So, the encryption code generated by the present invention installed at client's computer is dependent on Local Language entered by Internet users. An administration server issues the same encryption code as generated at the user computer, and installs it at the Internet site of a Real Domain converted from the Virtual Domain. The encryption code issued by the administration server may be installed at the title section of the Internet site. When Internet users enter a Virtual Domain name, the present invention installed at client computer generates an encryption code for the specific Virtual Domain name, navigates the various Real Domain names converted from the Virtual Domain name, and list certain information (i.e. title information) downloaded from the existing sites of the Real Domain names converted from the Virtual Domain name. Using the downloaded information, the present invention searches for an encryption code installed at a server and compares it with the encryption code generated at client's computer. If there is a matching encryption code between the encryption code generated at client's computer and the encryption code downloaded from a server, the present invention considers the Internet site of the Real Domain name with the valid encryption code installed as the right Internet site for the Virtual Domain entered by users. Therefore, the contents of the Real Domain name site with encryption code installed will be displayed at client's monitor and the contents of the other existing Real Domain names converted from the Virtual Domain will be listed in a list box or container.

For example, the ‘www. [symbol] of Korean Virtual Domain name may have four converted Real Domain names; ‘www.mall.com,’ ‘www.mol.com,’ ‘www.maul.com’ and ‘www.mole.com.’ Assuming that only ‘www.mall.com’ and ‘www.mol.com’ have active existing Internet sites and that ‘www.mall.com’ has the encryption code for ‘www. [symbol] the Virtual Domain name entered by a user, the site of ‘www.mall.com’ is connected to and displayed at the user's computer. The title information of the ‘www.mol.com’ is listed in a list box or a container of the user's computer.

The encryption code to be installed at a server has more information than the encryption code to be generated at client's computer. The encryption code installed at a server has information about not only Virtual Domain name in Local Language and type of language, but also IP address, expiration date and other necessary information. The IP address information will protect the unique encryption code not to be stolen and installed at a different server. The encryption code at a server will be automatically broken and will not work if the encryption code is moved to a different server with different IP address. The encryption code at a server will not work either if the expiration date is passed. The type of language information will be used to find what language the Internet users use and to connect to the web pages prepared in the users' preferred language, if any.

The present invention has learning memories at client computer to record users' habits of Internet usage. Once a user visits a Virtual Domain name, the learning memories record the Virtual Domain name, existing and non-existing Real Domain name(s) converted from the Virtual Domain name, the Real Domain name with encryption code installed, the lastly visited site among the existing Real Domain name(s) and other necessary information. When a user inputs a Virtual Domain name, the present invention searches for the same Virtual Domain name in the learning memories. If the Virtual Domain name is found from the learning memories, the present invention connects to the Internet site of the Real Domain name(s) with encryption code installed, if found. The present invention connects to the Real Domain name lastly visited, if no encryption code is found. The certain information of the other existing Real Domain name(s) will be listed in a list box or container. If the Virtual Domain name is not found from the learning memories, the present invention performs the routine navigation, which navigate the Real Domain name(s) converted from the Virtual Domain name. The learning memories may keep updated as users navigate Internet.

The present invention has a list box or container to show certain information, such as title information, downloaded from the non-displayed existing sites out of the Real Domain names converted from a Virtual Domain name entered by a user. Such non-displayed existing sites are usually the sites of the Real Domain names whose pronunciation is same as or very similar to the Virtual Domain names entered by Internet users. If the Internet user wants to move to one of the non-displayed active sites, he or she can easily click the title information and the contents of the clicked site will be displayed at the Internet user's monitor. Accordingly, the list box or container shows the sites of Real Domain name(s) which are pronounced same or very similar to the Virtual Domain name.

The list box or container can show other Internet sites, which are in business and industry nature same as or similar to the site being displayed at client computer. So while an Internet user is visiting a site, the Internet user can easily move to the similar sites in business nature or to the sites of competing companies or products. The present invention sends from client computers to certain servers Virtual Domain name entered by Internet users, Real Domain name(s) converted from the entered Virtual Domain name and other information as users enter them and navigate Real Domain names. The receiving servers contain the information of similar or alternative sites or competing sites for companies or products, which are related to specific Virtual Domain or Real Domain names. As the servers receive from client computer the Virtual Domain name entered by users and the converted Real Domain names, the servers will send back to the client computer and shows in the list box or container the information of similar sites in the same industry or competing company's sites, which are kept in the servers.

Implementation of the Conversion System

In a preferred arrangement, the present invention is implemented at the user's computer. That is, the conversion of Virtual Domain in Local Language into the corresponding Real Domain names in English takes place at the user's computer before domain name requests are sent to the user host's local DNS server. Thus, neither a special encoding nor a separate lookup service is needed to implement the present invention. The present invention does not need any changes to the DNS and is fully compatible with the DNS. The present invention also preserves the hierarchical dotted notation of current domain names, while the principles of the present invention are also applicable to domain names in other possible notations such as those in a natural language (e.g., ‘microsoft windows’ rather than ‘windows.micorsoft.com’). The present invention is also modularized with each module being used for conversion of Virtual Domain names entered in one local language into the corresponding Real Domain names in English. Users would need only the module for conversion of their preferred Local Language into English. For example, a user who prefers to enter Virtual Domain names in Korean needs only the module for conversion of Korean into English. The present invention can be embedded into the software for various Internet features such as Web browsing, e-mail, telnet, ftp, and so on, or it can work as an add-on to such software. In either case, the present invention captures Virtual Domain names entered in Local Language, converts them into the corresponding Real Domain names in English, and returns the real domain names in English to the software for Internet access. This process takes place automatically and is transparent to the user. Even when the DNS accepts and registers domain names in any other languages in addition to English, the conversion system of the present invention allows the user to enter Virtual Domain names in any language of the user's preferred language by converting them into the corresponding Real Domain names in another language. Taken together, these features of the present invention achieve all the aforementioned objects.

The present invention also can be implemented at a central server host or a cluster of local server hosts. A central server host with all the modules of the present invention can provide the conversion service for all Local Languages, or a cluster of local server hosts can share the conversion service. In the latter case, each local server host with a module or set of modules can provide the conversion service for the respective Local Language or set of Local Languages that are used in a certain country or region. For example, a local server host in Korea, with the module for Korean-English conversion can provide the conversion service for Korean, and a local server host in Switzerland, with the modules for French-English and German-English conversion, can provide the conversion service for French and German. When the present invention is implemented at a central or local server host, the user accesses the server host's Web page, using the Web browser installed at the user host, and enters a Virtual Domain name in the local language into the server host's Web page. Then, the server host captures the Virtual Domain name in the Local Language and invokes the conversion module for the Local Language. The conversion module converts the Virtual Domain name in the Local Language into the corresponding Real Domain name in English, following the aforementioned principles of the present invention. After the conversion, the server host may by the user's preference send the Real Domain names in English back to the user host for use by the user or link directly to the server host for which the user requested the Real Domain name in English.

The present invention can also be extended to various Internet devices other than wired personal computers. The present invention can be embodied into wireless or mobile phones as well as regular telephones. The present invention further applied to Internet appliances including, but not limited to, refrigerators and TV set-top box, which are manufactured for Internet accesses in addition to their traditional functions. The present invention can be applied to voice access to Internet as the present invention can convert Local Domain names entered by user's voice to Roman Domain names. Users speaking Local Languages may enter Local Domains by voice, and then the present invention can convert the Local Domains (Virtual Domains) to Roman Domains (Real Domains) in accordance with the principles of the present invention. The present invention can be further applied to dual search engines, which search for both Local, and Roman databases with one input either in Local or Roman. The present invention can be further applied to various database system or devices such as personal electric organizers or personal digital assistants (PDAs) and such kind as it can transliterate Local Languages to Roman Language or vice versa, or search for both Local Language and Roman Language queries with one input either in Local Language or English.

In implementing the present invention in the aforementioned preferred arrangement, the only requirements on the part of the user are to install the conversion system at the user's host and to enter Virtual Domain names in the Local Language in accordance with the principles of the present invention. The only requirement on the part of the entity whose server host provides Internet services to user hosts is to have a Real Domain name in English into which a Virtual Domain name in the Local Language is similarly transliterated in accordance with the principles of the present invention. If the entity has such domain name in English, the entity continues to use it and the user would access the entity's server host by the user's preference using either the Real Domain name in English or the equivalent Virtual Domain name in the Local Language. If the entity does not have such domain name in English, the entity needs to register a new domain name in English into which a Virtual Domain name in the Local Language is similarly transliterated in accordance with the principles of the present invention. If the entity wants to keep the current domain name in English for some reasons (e.g., longstanding organization names, brand names, and trademarks), the new domain name in English for which an equivalent Virtual Domain name in the Local Language exists in accordance with the principles of the present invention can serve as a linkage to the current domain name in English. In either case, the entity can promote its Virtual Domain name in the Local Language for local users, as the Virtual Domain name in the Local Language is easier for local users to remember and type and more meaningful in the local context.

Domain Name Registration Log-in ID Registration, Log-in Password, Subdirectory Set-up in Local Languages

The conversion methodologies of the present invention can be applied in registering or setting up domain names, log-in ID's, log-in passwords or path names for subdirectories using local languages which can be converted into English interchangeably. Users input English alphabets when they register domain names, as English alphabets are one of the few language alphabets accepted for domain names. Log-in ID's of certain web sites or internet service providers are often used as email addresses of the web sites or internet service providers. Therefore, log-in ID's of such web sites or internet service providers are currently required to be English alphabets. Log-in passwords and subdirectories of certain web sites or internet service providers are often comprised of English alphabets. Specially, when subdirectories of certain web sites or internet service providers are used for web pages or personal home pages, they are required to be in English alphabets. In those circumstances described above, the present invention can be applied so that local languages and English may be used interchangeably. As the present invention can be embodied in either client or server level, users are very flexible using it in any web sites.

For example, when a Korean user tries to register ‘ [symbol] as his or her domain name, he or she often converts the Korean alphabets into English alphabets first, then inputs the English alphabets for actual registration process. However, the present invention converts ‘ [symbol] into ‘hangeulinternet.com’ automatically using the conversion methodologies of the present invention and begin the registration process of internet domain names immediately. This will help users to register internet domain names in the local alphabets of their own languages and promote the virtual domain names of local languages and real domain names of English together.

When a Korean user tries to register an account with Yahoo.com or any other web sites for a web email or a personal home page, he or she should provides an ID in English, as English is one of the few languages accepted in internet currently. If he or she wants to have ‘ [symbol] as an web email account with Yahoo.com, he or she often converts the Korean alphabets into English alphabets first, then inputs the English alphabets for actual registration process. However, the present invention converts ‘ [symbol] into ‘hangeulinternet.yahoo.com’ automatically using the conversion methodologies of the present invention and begin the registration process of a Yahoo ID immediately. This technology will help users to register an email address or a personal web page of certain web sites or internet service providers in their own languages, and promote the virtual email or personal home page addresses of local languages and real email or personal home page addresses of English together.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A method of converting a virtual domain name at least part of which is entered in a first language into a real domain name in a second language by a user using a computer system, comprising the steps of:
inputting the virtual domain name to the computer system;
determining whether the input virtual domain name includes parts entered in the first language;
converting the virtual domain name into one or more real domain names using a knowledge database structured to set the priority among phonemes in the first language and the corresponding phonemes in the second language in accordance with the determined result; and
generating an encryption code for each virtual domain name.

2. The method of claim 1, wherein said converting step comprises the steps of:
decomposing the virtual domain name into a first part in the first language and a second part in the second language;
dividing the first part into a code portion and an entity-defined part; and
converting the code portion into the corresponding code in the second language.

3. The method of claim 1, wherein said converting step comprises the steps of:
decomposing the virtual domain name into a first part in the first language and a second part in the second language;
dividing the first part into a code portion and an entity-defined portion; and
converting the entity-defined portion into the corresponding entity-definition in the second language.

4. The method of claim 1, wherein the first language is a local language and the second language is English.

5. The method of claim 1, further comprising the steps of:
decomposing the virtual domain name into a first part in the first language and a second part in the second language;
dividing the first part into a code portion and an entity-defined portion;
converting the code portion into the corresponding code in the second language; and
converting the entity-defined portion into the corresponding entity-definition in the second language.

6. The method of claim 5, further comprising the steps of:
bypassing conversion of the second part and combining the second part into the real domain name.

7. The method of claim 6, further comprising the steps of:
determining whether there exists only one real domain name in the second language corresponding to the virtual name; and
if so, using the real domain name to access the corresponding internet site.

8. The method of claim 6, further comprising the steps of:
determining whether there exist more than one real domain name in the second language corresponding to the virtual name; and
if so, navigating all the corresponding real domain names and displaying all the existing real domain names to allow the user to select one of them.

9. The method of claim 5, wherein the converting step includes:
dividing the code portion in the first language into a top-level code portion and a second-level code portion;
converting the top-level code portion in the first language into a corresponding code in the second language; and
converting the second-level code portion in the first language into a corresponding code in the second language.

10. The method of claim 9, wherein said step of converting the top-level code portion includes the step of matching the top-level code portion in the first language to the top-level code portion in the second language, and the top-level code portion in the second language is pre-assigned to the equivalent top-level code portion in the first language.

11. The method of claim 9, wherein said step of converting the second-level code portion includes matching the second-level code portion in the first language to the second-level code portion in the second language, and the second-level code portion in the second language is pre-assigned to the equivalent second-level code portion in the first language.

12. The method of claim 11, wherein the first language is a local language, and the second language is English.

13. The method of claim 9, wherein said step of converting the top-level code portion in the first language includes the steps of:
dividing the top-level code portion in the first language into at least one individual letter which represents one phoneme;
matching the phoneme in the first language to phonemes in the second language; and
combining the matched phonemes which represent the top-level code portion in the first language with the top-level code portion in the second language.

14. The method of claim 9, wherein said step of converting the top-level code portion includes the steps of:
converting any part of the first-level code portion into a corresponding code in the second language based on the principles of transliterating the first language into the second language according to the standard pronunciation of the first language; and.
combining all the transliterated parts which represent the top-level code portion in the first language with the corresponding top-level code portion in the second language.

15. The method of claim 9, wherein said step of converting the second-level code portion includes the steps of:
dividing the second-level code portion in the first language into phonemes in the first language;
matching the phonemes in the first language to phonemes in the second language; and
combining the matched phonemes which represent the second level-code portion in the first language with the second-level code portion in the second language.

16. The method of claim 9, wherein said step of converting the second-level code portion includes the steps of:
converting any part of the second-level code portion in the first language into a corresponding code in the second language based on the principles of transliterating the first language into the second language according to the standard pronunciation of the first language corresponding to the individual letters of the second language; and
combining all the transliterated parts which represent the second-level code portion in the first language with the corresponding second-level code portion in the second language.

17. The method of claim 5, wherein said step of converting the entity-defined portion includes the step of converting the entity-defined portion in the first language into the corresponding entity-defined portion in the second language, and at least one entity-defined portion in the first language included in the virtual domain is translated and transliterated into the second language.

18. The method of claim 17, wherein said step of converting the entity-defined portion includes the step of:
dividing the entity-defined portion in the first language into at least one individual letter which represents one phoneme;
translating and transliterating the phoneme in the first language into phonemes in the second language; and
combining the translated and transliterated phonemes with the entity-defined portion in the second language.

19. The method of claim 17, wherein said step of converting the entity-defined portion includes the steps of:
converting the entity-defined portion in the first language into the corresponding entity-defined portion in the second language based on the principles of transliterating the first language into the second language according to the standard pronunciation of the first language; and
editing all the transliterated parts which represent the entity-defined portion in the first language into the entity-defined portion in the second language.

20. The method of claim 18, wherein said step of converting the entity-defined portion includes the steps of:
decomposing the entity-defined portion in the first language into individual letters so that the individual letters can represent an individual phoneme of the first language, contrary to that the phonemes of the first language are transliterated into the letters of the first language;
matching each individual phoneme of the first language with a phoneme in the second language that has the same or proximate sound;
transliterating the matched phoneme in the second language into a corresponding set of letters in the second language based on the standard pronunciation of the second language; and
combining all the transliterated letters with the second language.

21. The method of claim 1, wherein said step of converting the virtual domain name in the first language into the real domain name in the second language is performed in a host computer system before a request for the real domain name is sent to a DNS server.

22. The method of claim 1, wherein said step of converting the virtual domain name in the first language into the real domain name in the second language is performed in the computer system before a request for the real domain name is sent to a DNS server.

23. The method of claim 1, wherein the computer system is loaded in a regular telephone.

24. The method of claim 1, wherein the computer system is loaded in a wireless telephone.

25. The method of claim 1, wherein the computer system is loaded in a personal digital assistant (PDA) unit.

26. The method of claim 1, wherein the computer system is loaded in a TV set-top box.

27. The method of claim 1, wherein the computer system is loaded in a household appliance.

28. A method of converting a virtual domain name entered by a user in a first language (local language) into a real domain name in a second language (roman language), comprising the steps of:
building a knowledge database containing knowledge on phonemes and words of the local language and the roman language;
generating encryption codes corresponding to the virtual domain name entered in the local language;
converting the virtual domain name into the real domain name in accordance with each encryption code;
navigating the Internet using the converted real domain name to request related information; and
performing learning memory that records user habits according to the navigated result of the Internet.

29. The method of claim 28, wherein said knowledge database applies weight factors to phonemes and alphabets of the second language corresponding to individual phonemes of the first language based on the frequency and the importance of the real domain name in the second language in Internet usage, so that priority is set among phonemes in the phonemes and the alphabets of the second language.

30. The method of claim 29, wherein said knowledge database lists a plurality of real domain names for the virtual domain name in the order from the highest possibly existing one to the least possibly existing one in accordance with the set priority if the real domain names are converted.

31. The method of claim 28, wherein said knowledge database is structured to convert the virtual domain name into the corresponding real domain name if phonemes and a word of the second language is pronounced in various similar types of the first language and the virtual domain name is entered in various similar types.

32. The method of claim 28, wherein said knowledge database is structured to number the phonemes and alphabets of the second language corresponding to the individual phoneme and word of the first language so as to convert the virtual domain name into the corresponding real domain name if the virtual domain name of the first language is entered along with the corresponding number.

33. The method of claim 28, wherein the encryption codes are generated by the virtual domain name, a type of the local language, an effective data of the encryption codes, IP address information of a server to which the real domain name is assigned, and other information.

34. The method of claim 28, wherein the one virtual domain name includes one encryption code in host computers of all users.

35. The method of claim 28, wherein the encryption code corresponding to the one virtual domain name is assigned to one of the plurality of real domain names that can exist for the virtual domain name, and recorded in a server which contains title information of an Internet site having the real domain name to which the encryption code is assigned.

36. The method of claim 28, wherein the encryption codes are assigned and converted under the control of an encryption code administration server.

37. The method of claim of claim 28, wherein said learning memory is updated according to the user based navigation of the Internet by recording the user habits in the host computer of the user.

38. The method of claim 28, wherein said learning memory is to record the virtual domain name entered by the user, the real domain name selected by the user corresponding to the virtual domain name, and the encryption code corresponding to the real domain name.

39. The method of claim 28, further comprising the step of navigating the Internet after converting the virtual domain name into the real domain name selected by the user if the virtual domain name exists in the learning memory.

40. The method of claim 28, wherein said step of navigating the Internet includes the steps of:
if the converted real domain name is one, requesting a DNS server to provide an IP address corresponding to the one real domain name;
navigating the Internet using the corresponding IP address; and
connecting the host computer of the user to the DNS server.

41. The method of claim 28, wherein said step of navigating the Internet includes the step of, if a plurality of the converted real domain names exist, requesting a DNS server to provide an IP address in the order from the highest possibly existing one to the least possibly existing one in accordance with the set priority, thereby determining the existence and activity of the converted real domain names.

42. The method of claim 28, wherein said step of navigating the Internet includes the steps of:
if the converted real domain name is one, navigating the Internet using an IP address of the corresponding real domain name, and
connecting the host computer of the user.

43. The method of claim 28, wherein said step of navigating the Internet includes the step of:
if a plurality of the converted real domain names exist, navigating the Internet using a corresponding IP address in the order from the highest possibly existing one to the least possibly existing one in accordance with the set priority; and
downloading server information such as title information of the corresponding IP address.

44. The method of claim 43, further comprising the step of identifying there exist encryption codes in the downloaded title information if a plurality of the converted real domain names exist.

45. The method of claim 44, wherein said step of navigating the Internet includes the steps of:
if a plurality of the converted real domain names exist, and if the encryption codes exist in the converted real domain names, preferentially connecting the host computer of the user to an Internet site of the real domain name having the encryption codes; and
listing the other real domain names and corresponding title information in a separate list box or container to allow the user to select them.

46. The method of claim 45, wherein said step of navigating the Internet includes the step of connecting the host computer of the user to a corresponding web page prepared in a corresponding local language among web pages of the corresponding Internet site using local language information included in the encryption codes, if the host computer of the user is preferentially connected to the Internet site of the real domain name having the encryption codes.

47. The method of claim 44, wherein said step of navigating the Internet includes the steps of:
if a plurality of the converted real domain names exist, but if the encryption codes do not exist in the converted real domain names, preferentially connecting the host computer of the user to an Internet site of the real domain name having the highest priority in accordance with the set priority list; and
listing the other real domain names and corresponding title information in a separate list box or container to allow the user to select one of them.

48. The method of claim 47, wherein said step of navigating the Internet includes the step of, if the user selects the real domain name or title information listed in the list box or container, connecting the host computer of the user to the Internet site of the selected real domain name.

49. The method of claim 28, wherein said step of navigating the Internet includes the steps of:
if the real domain name to be connected with the host computer of the user is determined, sending the determined real domain name, its corresponding virtual domain name, and downloaded title information to a specific server; and
requesting new information related to the sent information.

50. The method of claim 49, further comprising the step of:
inquiring whether there is any information related to the Internet site of the real domain name or the web page which will be connected with the host computer of the user; and
if there is either any information such as sites of competing companies, their products and services or information banners, sending them to the host computer of the user; and
listing them in a separate list box or container so that the user can select them.

51. The method of claim 50, wherein said step of navigating the Internet includes the step of, if the user selects said information listed in the list box or container, connecting the host computer of the user to a site related to the selected information.

52. The method of claim 28, wherein said step of navigating the Internet includes the steps of:
connecting the host computer of the user to an Internet site of a specific real domain name and at the same time displaying a list box or container listing similar domain names existing among the converted real domain names; and
providing a list box or container box guiding information such as sites of competing companies, which will be connected with the host computer of the user, their products and services, thereby allowing the user to simultaneously use the similar domain names and related information.
